(19) United States
(12) Patent Application Publication
(10) Pub. No.: US 2026/0288882 A1
(43) Pub. Date: Sep. 24, 2026

(54) Automated Topic Exploration

(71) Applicant: Google LLC, Mountain View, CA (US)

(72) Inventors: Jana Stýblová, Durham, NC (US); Cheng-Wei Hu, San Francisco, CA (US); Justin Michael Pacione, San Francisco, CA (US); Shan Wang, Mountain View, CA (US); Adam Joshua Bignell, Mountain View, CA (US)

(21) Appl. No.: 19/394,752

(22) Filed: Nov. 19, 2025

Related U.S. Application Data
(60) Provisional application No. 63/775,223, filed on Mar. 20, 2025.

(51) Int. Cl. G06F 16/9532

(52) U.S. Cl. CPC G06F 16/9532

(57) ABSTRACT

A method to perform automated topic exploration includes: receiving, by a computing system comprising one or more computing devices, a request to initiate an automated topic exploration; in response to the request, processing, by the computing system, a model input with a machine-learned topic generation model to generate a topic statement as an output of the machine-learned topic generation model; generating, by the computing system, a plurality of information retrieval queries that query for source documents related to the topic statement; causing, by the computing system, the plurality of information retrieval queries to be executed on one or more information retrieval systems to return a plurality of candidate source documents that are responsive to the plurality of information retrieval queries; and collecting, by the computing system at least a subset of the plurality of candidate source documents into a proposed set of source documents.

### RELATED APPLICATIONS

This application claims priority to and the benefit of United States Provisional Patent Application Number 63/775,223, filed Mar. 20, 2025 and titled “Automated Topic Exploration”. United States Provisional Patent Application Number 63/775,223 is hereby incorporated by reference in its entirety.

### FIELD

The present disclosure relates generally to machine learning processes and machine-learned devices and systems. More particularly, the present disclosure relates to systems and methods for automated topic exploration, for example within the context of a notebook application.

### BACKGROUND

In the field of automated content exploration, a significant technical problem arises from the tendency of existing systems to generate non-diverse content. This leads to frequent redundancy in the computational efforts required to retrieve and curate information. Specifically, when existing systems fail to introduce sufficient variability in the topics they generate, they often repeatedly process and present information about the same or closely related topics. This redundancy not only wastes computational resources but also limits the system’s efficiency by repeatedly engaging in the same retrieval and analysis processes.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

One general aspect includes a computer-implemented method to perform automated topic exploration. The computer-implemented method includes receiving, by a computing system which may include one or more computing devices, a request to initiate an automated topic exploration; in response to the request, processing, by the computing system, a model input with a machine-learned topic generation model to generate a topic statement as an output of the machine-learned topic generation model; generating, by the computing system, a plurality of information retrieval queries that query for source documents related to the topic statement; causing, by the computing system, the plurality of information retrieval queries to be executed on one or more information retrieval systems to return a plurality of candidate source documents that are responsive to the plurality of information retrieval queries; and collecting, by the computing system at least a subset of the plurality of candidate source documents into a proposed set of source documents. Other embodiments of this aspect include corresponding computer systems, apparatus, and computer programs recorded on one or more computer storage devices, each configured to perform the actions of the methods.

Implementations may include one or more of the following features. The computer-implemented method, where the request to initiate the automated topic exploration is responsive to a user input that selects a user interface element that initiates the automated topic exploration. Processing, by the computing system, the model input with the machine-learned topic generation model to generate the topic statement as the output of the machine-learned topic generation model may include: randomly selecting, by the computing system, two or more seed data elements from a corpus of data elements, each data element in the corpus of data elements may include textual content, image content, or audio content; and processing, by the computing system, the two or more seed data elements with the machine-learned topic generation model to generate the topic statement as the output of the machine-learned topic generation model. The two or more seed data elements may include two or more words. The two or more words may include two or more nouns. The corpus of data elements is dynamically modified based on user information associated with a user. The corpus of data elements is dynamically modified based on current news events. Generating, by the computing system, the plurality of information retrieval queries that query for source documents related to the topic statement may include: processing, by the computing system, the topic statement with one or more machine-learned query generation models to generate one or more of the plurality of information retrieval queries as outputs of the one or more machine-learned query generation models. Processing, by the computing system, the topic statement with one or more machine-learned query generation models may include processing, by the computing system, the topic statement along with a query generation prompt with one or more machine-learned query generation models to generate one or more of the plurality of information retrieval queries as outputs of the one or more machine-learned query generation models, where the query generation prompt instructs the one or more machine-learned query generation models regarding generation of the one or more of the plurality of information retrieval queries based on the topic statement. Generating, by the computing system, the plurality of information retrieval queries that query for source documents related to the topic statement may include: heuristically generating, by the computing system, one or more of the plurality of information retrieval queries from the topic statement. The one or more information retrieval systems may include a web search engine. The plurality of candidate source documents may include web documents. The one or more information retrieval systems may include an enterprise document storage system. Collecting, by the computing system at least the subset of the plurality of candidate source documents into the proposed set of source documents may include: filtering, by the computing system, the plurality of candidate source documents based on one or more source document selection criteria to generate the proposed set of source documents. Collecting, by the computing system at least the subset of the plurality of candidate source documents into the proposed set of source documents may include: processing, by the computing system, the plurality of candidate source documents with one or more machine-learned result selection models to generate, as an output of the one or more machine-learned result selection models, a selection or ranking of the plurality of candidate source documents into the proposed set of source documents. Processing, by the computing system, the plurality of candidate source documents with one or more machine-learned result selection models may include: processing, by the computing system, the plurality of candidate source documents and a source document selection prompt with one or more machine-learned result selection models, where the source document selection prompt instructs the one or more machine-learned result selection models regarding one or more source document selection criteria. The one or more source document selection criteria may include a cohesion criteria and a progressive complexity criteria. The method may include: providing for display, by the computing system, a graphical user interface that identifies the proposed set of source documents; receiving, by the computing system, a user input that selects one or more of the source documents from the proposed set of source documents; and in response to the user input, creating, by the computing system, within an interactive notebook application, a new notebook that contains the one or more source documents selected by the user input. Processing, by the computing system, the two or more seed data elements with the machine-learned topic generation model may include processing, by the computing system, the two or more seed data elements with the machine-learned topic generation model along with a topic generation prompt that instructs the machine-learned topic generation model regarding generation of the topic statement based on the two or more seed data elements.

Implementations of the described techniques may include hardware, a method or process, or computer software on a computer-accessible medium. Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example notebook application according to example implementations of aspects of the present disclosure;

FIG. 2 is an example graphical user interface according to example implementations of aspects of the present disclosure;

FIG. 3 is an example graphical user interface according to example implementations of aspects of the present disclosure;

FIGS. 4A and 4B are block diagrams of example computing systems according to example implementations of aspects of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Example aspects of the present disclosure are directed to computer systems and methods for automated topic exploration. As one example, the proposed systems and methods for automated topic exploration can be implemented within the context of a digital notebook platform. For example, the proposed techniques can be used to identify source documents which can serve as a starting point for a new notebook within the digital notebook platform.

Traditional methods of topic generation often suffer from limitations such as repetitive and predictable outputs, which can lead to user disengagement. The technology described in the present disclosure addresses these issues by utilizing machine-learned models to generate diverse and intriguing topic suggestions.

In some implementations, the initiation of the topic exploration process can be triggered by a user’s interaction with a specific user interface element, such as an “I’m Feeling Curious” button or other element that indicates a desire to perform a topic exploration. This action can lead to a sequence of computer-implemented operations that can include the generation of a topic statement using a machine-learned topic generation model. For example, the system can randomly select two or more data elements (e.g., two or more words such as nouns) from a corpus of data elements. The system can use these selected data elements as inputs to the machine-learned topic generation model to cause the model to generate a topic statement (e.g., that conceptually links the input elements, such as nouns, in an intriguing way).

Following the generation of the topic statement, the system can then create multiple information retrieval queries. These queries are designed to fetch source documents that are relevant to the generated topic and can be considered as candidates for provision to the user. In some implementations, the queries themselves can be formulated using another set of machine-learned models and/or other techniques such as heuristic approaches. The multiple different information retrieval queries can collectively ensure that the search terms are varied, while still pertinent to the topic.

The search results obtained from executing these queries are then processed to select a subset of documents that meet certain criteria. These criteria can include cohesion, progressive complexity, and/or other criteria. The selection criteria can result in a subset of documents that not only adhere to the topic but also facilitate a learning path from basic to advanced concepts. This curated set of source documents can then be presented to the user, who can choose to explore them further within the notebook platform.

Thus, the systems and methods described herein offer significant improvements over traditional topic generation techniques by reducing model repetition (e.g., which results in reduced consumption of computing resources). This approach not only enhances the user experience but also leverages the capabilities of machine learning to improve the computational efficiency of digital content curation.

More particularly, one example use for the proposed topic exploration techniques is within the context of a notebook application or platform. A notebook application or platform can be implemented as a software application that facilitates the organization, manipulation, and/or analysis of various types of information (e.g., contained in documents) in a structured and interactive environment. For example, users can aggregate, annotate, and review content ranging from text documents and PDFs to multimedia files within different self-contained digital notebooks. The notebook application can include features such as search functionalities, tagging, collaborative tools, and/or machine learning capabilities to enhance information retrieval and content understanding. For example, a user can interact with one or more machine-learned models (e.g., generative language models) to explore, learn, or otherwise discuss the information, concepts, or other semantic content contained within a particular notebook.

In some implementations, the topic exploration techniques described herein can be initiated in response to a request to initiate an automated topic exploration. This request can be automatically triggered under certain circumstances (e.g., a new or returning user opening the notebook application). Alternatively or additionally, this request can be triggered by a specific user action, such as a user selecting a designated button or entering a specific command within a user interface. For example, in the notebook application, a user can click an “I’m Feeling Curious” button, which signals the system to begin the process of generating a unique and engaging topic for exploration.

As another example, the request to initiate the automated topic exploration can be part of an offline process for generating large numbers of topics and/or corresponding sets of source documents, as described further below. Thus, the system can be configured to recognize various forms of user inputs and/or automatically-evaluated criteria as valid triggers for starting the topic exploration process.

In some implementations, following the receipt of the request to initiate topic exploration, the computing system can process a model input with a machine-learned topic generation model to produce a topic statement. The model can analyze and synthesize information contained in the model input to generate diverse topic statements.

In particular, in some implementations, the computing system can randomly select two or more seed data elements from a corpus of data elements to initiate the topic generation process. These data elements can include textual content, image content, audio content, and/or other forms of information or content. As one example, the system can select an image of a historical monument and a text snippet about artificial intelligence to generate a topic that explores the influence of technology on archaeology.

In some implementations, the selected seed data elements primarily include two or more words. In some implementations, the words selected as seed data elements are specifically nouns. This can help in generating topics that are concrete and centered around tangible subjects or entities. For example, selecting nouns like “bee” and “pollination” can lead to generating content focused on ecological relationships and conservation.

In some implementations, the noun database used for generating topics can be expanded beyond the initial 1000 nouns to include tens of thousands of nouns, specialized nouns, and/or multilingual nouns. This expansion enhances the diversity of the topics that can be generated, thereby reducing the likelihood of repetitive suggestions.

In some implementations, the technology can be extended to include an increased noun combination count, moving from pairs to triplets or even larger groups of nouns. This enhancement can exponentially increase the topic space available for generating intriguing and complex topics. This capability allows for more sophisticated abstractions and can effectively address the limitations of direct topic generation, which can otherwise yield repetitive or overly simplistic topics.

In some implementations, the technology can include a variety of word classes such as verbs, adjectives, and adverbs in the selection process for generating topics, thereby broadening the scope and enhancing the novelty of the topics. This diversity in word classes allows the system to create topics that are not only focused on specific entities or nouns but also encompass actions, qualities, and the nature of relationships.

In some implementations, the corpus of data elements from which seed data are selected is dynamically modified based on user information. This dynamic modification allows the system to adapt the corpus of possible data elements to the individual user’s past interactions, preferences, or other information. For example, if a user frequently engages with topics related to technology, the system can prioritize inclusion of nouns like “artificial intelligence” (AI) or “robotics” within the corpus of possible seed elements.

In some implementations, the corpus of data elements is additionally or alternatively dynamically updated based on current news events or other dynamic signals. This ensures that the topics generated are timely and relevant, potentially increasing user engagement by aligning with global or local trends. For example, during a global sports event, the system can include more sports-related content in the corpus, such as “athlete” or “Olympics,” to generate topics that resonate with current public interest.

In some implementations, in addition to the seed data elements, the computing system can provide the machine-learned topic generation model with a topic generation prompt. This prompt can provide instructions to the topic generation model on how to utilize the (arbitrary) seed data elements effectively to generate a coherent and contextually-relevant topic statement. For example, the topic generation prompt can direct the model to explore creative and insightful connections between the elements. This prompt can increase the likelihood that the topic generation process consistently yields compelling and thought-provoking topics.

Having generated the topic statement, the computing system can next generate a plurality of information retrieval queries that are designed to query for source documents related to the topic statement. This process can include translating the topic statement into multiple search queries that can effectively retrieve diverse and relevant documents from various databases, online sources, or other information repositories. The multiple different queries can result in a comprehensive exploration of the topic, resulting in retrieval of a wide range of documents that provide different perspectives and detailed information related to the subject matter.

In some implementations, the computing system can process the topic statement with one or more machine-learned query generation models to generate the plurality of information retrieval queries. The query generation model(s) can analyze the topic statement and produce queries that are specifically designed to retrieve documents closely related to the stated topic.

In some implementations, the processing of the topic statement with one or more machine-learned query generation models can include the use of a query generation prompt. This prompt can serve to instruct the query generation models on how to tailor the information retrieval queries based on the specific nuances of the topic statement. For instance, the query generation prompt can direct the query generation models to emphasize certain aspects of the topic, such as recent developments, without explicitly describing the topic itself. This approach allows the models to generate a variety of queries that, while diverse, remain focused on aspects relevant to the initial topic statement.

Additionally or alternatively to the use of the machine-learned query generation models, the computing system can heuristically generate one or more of the plurality of information retrieval queries from the topic statement. This heuristic generation process can include using rules or algorithms to transform the topic statement into effective search queries. As one example, a query can be constructed that simply corresponds to the topic statement itself. As another example, various keywords in the topic statement can be modified to match similar terms or synonyms. The use of model-generated queries and also heuristically-generated queries can result in a more diverse query set which returns more diverse candidate source documents.

After generating the information retrieval queries, the computing system can execute (or cause to be executed) the queries across one or more information retrieval systems. These systems can include web search engines, enterprise document storage systems, and/or other information repositories. For example, a web search engine can be utilized to fetch web documents. Additionally or alternatively, an enterprise document storage system can host a variety of document types such as reports, internal studies, and historical data. As a result of the queries, the computing system can receive, retrieve, or otherwise identify a plurality of candidate source documents.

The computing system can collect at least a subset of the plurality of candidate source documents into a proposed set of source documents. This selection process can include filtering and evaluating the retrieved documents to identify those that most effectively address the topic statement. This curated set of documents forms a focused resource pool that can, for example, be presented to a user to facilitate exploration of the topic.

In particular, in some implementations, the computing system can process the plurality of candidate source documents using one or more machine-learned result selection models to generate a selection or ranking of these documents into a proposed set of source documents. This process can include using the models to evaluate each document based on predefined criteria such as relevance, accuracy, and/or depth of content.

In some implementations, the processing of the candidate source documents with the machine-learned result selection models can include the use of a source document selection prompt. This prompt can provide specific instructions to the models regarding the criteria for selecting and ranking the documents. For example, if the desired focus is on practical applications rather than theoretical aspects, the prompt can direct the models to prioritize documents with case studies or real-world applications of the technology being discussed. This prompt helps in controlling the selection process, increasing the likelihood that the documents selected for inclusion in the proposed set meet the objectives of the topic exploration process.

In some implementations, the source document selection criteria used by the machine-learned result selection models can include cohesion criteria and/or progressive complexity criteria. The cohesion criteria can evaluate whether the selected documents are thematically consistent and logically connected. This criteria can increase the likelihood that the proposed set of source documents provides a coherent understanding of the topic. The progressive complexity criteria, on the other hand, can evaluate whether the documents not only cover basic introductory information but also include more detailed and advanced discussions as part of the set. This approach can create a proposed set of source documents that begin with foundational concepts and then progressively delve into more complex aspects. A set of source documents with progressive complexity can facilitate a structured learning path that is beneficial for educational purposes or in-depth research projects.

The computing system can provide a graphical user interface (GUI) that displays the proposed set of source documents to the user. This interface can allow the user to review and select some or all of the source documents that are of interest to them. For example, the GUI can present a list or grid of document titles, along with brief summaries or tags indicating the content’s focus. Users can interact with this interface by selecting one or more of the source documents they wish to explore further.

For example, upon receiving user input that selects one or more documents from the subset of source documents, the system can then create a new notebook within an interactive notebook application, incorporating the selected documents. This notebook serves as a dedicated space where users can view, annotate, and manipulate the content contained within the notebook. For example, once a user selects documents for inclusion in their notebook, the module can automatically summarize the content, highlight key concepts, map out the relationships between different ideas within the text, and generate relevant questions that prompt further exploration or study. The integration of source documents into a user-manipulable digital notebook increases the interactivity of the learning or research process.

As noted above, in some implementations, in addition or alternatively to initiation by a human user, the process described above can be performed as part of an offline evaluation feature that proactively generates topics offline. This approach allows the system to prepare a diverse array of topics in advance, thereby eliminating the latency typically associated with real-time topic generation when a user initiates a query. For example, the system can utilize times of low user activity (e.g., when interaction or processing count is below a threshold) to process and store a variety of intriguing topics, which can then be made available for user selection.

In some implementations, the system can also incorporate a user feedback loop in which the system learns from user interactions. For example, users can provide ratings or feedback on the topics generated by the system, which can then be used to refine and improve the topic generation algorithms. This feedback can help in optimizing the relevance of the topics to user interests and reducing the occurrence of repetitive suggestions.

The systems and methods of the present disclosure provide a number of technical effects and benefits. As one example, some example implementations utilize a topic generation method that includes abstracting from two or more seed data elements. For example, a system can select two nouns randomly from a predefined list and use these as inputs for a machine-learned topic generation model. This approach significantly diversifies the topics generated. For example, the use of randomness can help overcome the technical challenge of repetitive outputs common in traditional topic generation systems. As a result, the system can reduce the redundant processing of similar topics or queries, thereby conserving computational resources and enhancing the overall efficiency of the topic generation process.

As another technical effect and benefit, the proposed techniques can include a machine-learned model-driven process for curating search results based on criteria such as, for example, progressive complexity of content. This process organizes the search results into a structured learning pathway, guiding the user from basic to more complex information. This represents a technical improvement over conventional search systems that often provide unsorted bulk information. Providing source documents with progressive complexity can increase the efficiency with which a user can review and digest the source documents, which may correspondingly result in a reduction in time or computational resources spent by the user reviewing the source documents.

As yet another technical effect and benefit, the proposed techniques can include a machine-learned model-driven process for curating search results based on criteria such as, for example, the ability of source documents to be correctly ingested into the notebook platform. For example, source documents which are formatted or which contain content which would not be easily or correctly ingested into the notebook platform can be filtered or rejected. This can reduce the inclusion of low-ingestion documents within the collected set of source documents, thereby reducing unnecessary or unfruitful computational effort.

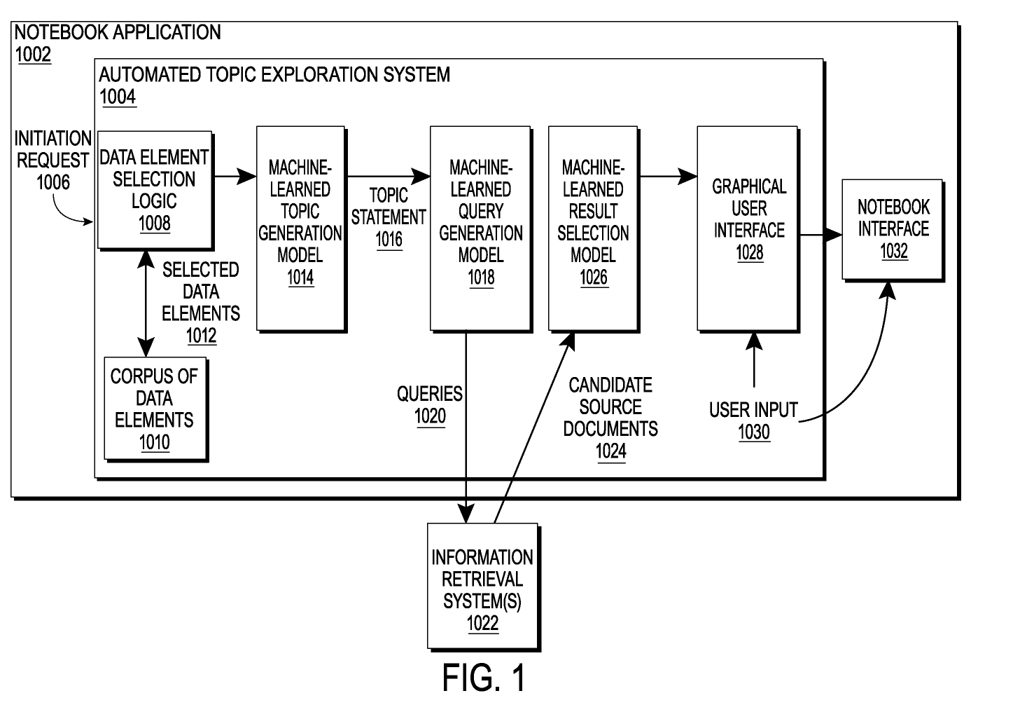

FIG. 1 illustrates a schematic diagram of the notebook application 1002, which can be configured to perform automated topic exploration within a digital environment. The diagram depicts an automated topic exploration system 1004, includes comprises several interconnected components that facilitate the generation and selection of topics based on user inputs and predefined data elements.

The process begins with an initiation request 1006, which can be triggered by a user action such as clicking a button or entering a command within the user interface of the notebook application 1002. Alternatively, the initiation request 1006 can be initiated automatically based on various triggers, objectives, or criteria. This initiation request 1006 signals the automated topic exploration system 1004 to commence the topic generation process.

Following the initiation request 1006, the data element selection logic 1008 selects data elements from a corpus of data elements 1010. The corpus of data elements 1010 can include various types of content such as textual, image, or audio data. The selection process facilitated by the data element selection logic 1008 can involve algorithms or methods that randomly or systematically choose data elements that will serve as inputs for generating a topic. The selected data elements 1012 are then forwarded to the next component in the system.

The machine-learned topic generation model 1014 receives the selected data elements 1012 and processes them to generate a topic statement 1016. The machine-learned topic generation model 1014 can utilize various artificial intelligence techniques, such as neural networks or decision trees, to abstract and link the selected data elements 1012 conceptually, forming a coherent topic statement 1016.

Once the topic statement 1016 is generated, it is used as input for the machine-learned query generation model 1018, which generates queries 1020. These queries 1020 are designed to retrieve information relevant to the topic statement 1016 from external or internal databases. The machine-learned query generation model 1018 can employ different strategies to formulate queries that are likely to yield useful and relevant results.

The queries 1020 are executed on one or more information retrieval systems 1022, which can include web search engines or specialized databases. The information retrieval systems 1022 process the queries 1020 and return a set of candidate source documents 1024 that are relevant to the queries 1020.

Subsequently, the candidate source documents 1024 are processed by the machine-learned result selection model 1026, which selects a subset of these documents based on predefined criteria such as relevance, coherence, and/or information richness, for example. The machine-learned result selection model 1026 can analyze content, metadata, and/or other attributes of the candidate source documents 1024 to determine which documents should be included in the final set presented to the user.

The selected documents are then presented through the GUI 1028 of the notebook application 1002. The GUI 1028 can display the documents in various formats, such as lists or cards, allowing the user to interact with the results. User input 1030 can be received via the GUI 1028, enabling users to select, modify, or further explore the presented documents.

Finally, the documents selected through user input 1030 are integrated into the notebook interface 1032, where they can be stored, annotated, and used as part of the user’s digital notebook. The notebook interface 1032 can serve as the primary interface where users interact with the content gathered and generated by the automated topic exploration system 1004.

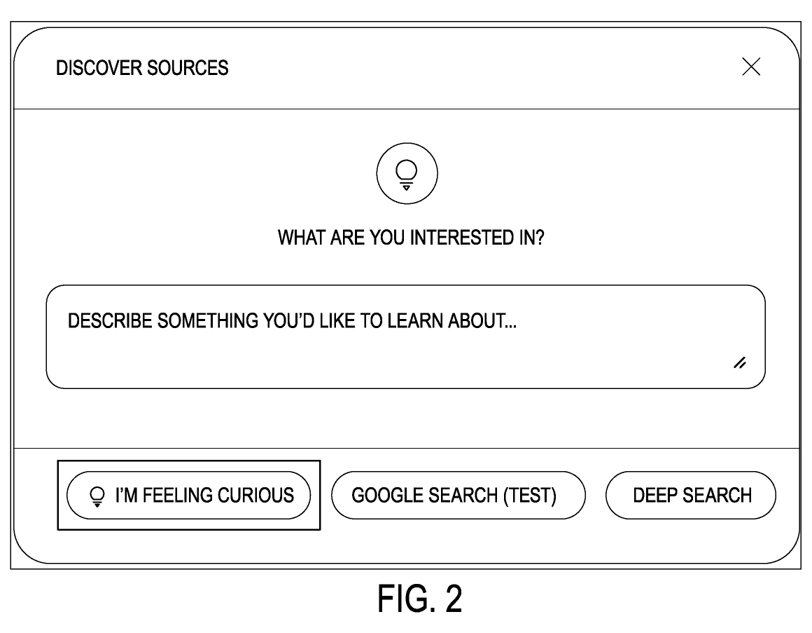

FIG. 2 depicts an example GUI within the notebook application, specifically designed for discovering sources. Below the search field, three buttons are displayed, each serving as an input method for different search or exploration functions. The first button, highlighted with a rectangle, is labeled “I’m feeling curious”. This button can be used to initiate an automated exploration of topics, potentially using predefined algorithms to suggest topics based on random or curated inputs.

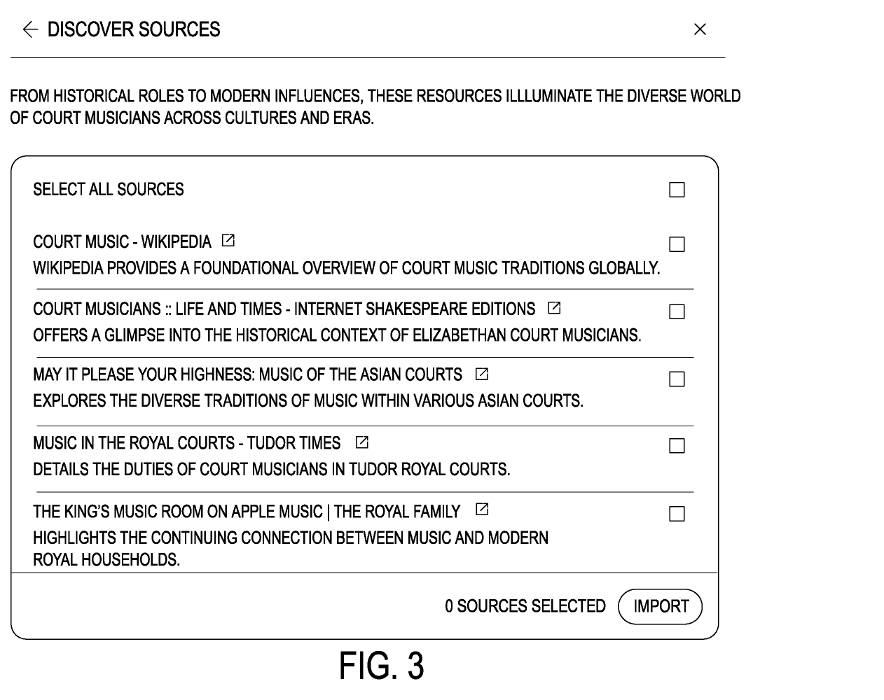

FIG. 3 displays an example GUI within the notebook application. This interface, titled “Discover sources,” presents a list of selectable source documents, each potentially relevant to the topic of court musicians across various cultures and historical periods. The interface includes a brief introductory text that contextualizes the type of information the user can expect to find in the listed sources. Below this text, there is an option labeled “Select all sources,” which allows the user to quickly select or deselect all listed documents.

Each source document in the list is accompanied by a checkbox, which users can mark to select individual sources they find relevant. Next to each checkbox, the title of the source document is provided, along with a short description or summary that highlights the content or focus of the source. For instance, one of the sources titled “Court music - Wikipedia” is described as providing a foundational overview of court music traditions globally. Additionally, each source includes a link, indicated by a linked chain icon, which can direct the user to the full content of the source for more detailed information. This link can be to external websites or databases where the full content is hosted.

At the bottom of the interface, a counter displays the number of sources currently selected by the user, and there is an “Import” button. This button can be used to incorporate the selected sources into the user’s digital notebook within the notebook application, facilitating further exploration or study of the chosen topics.

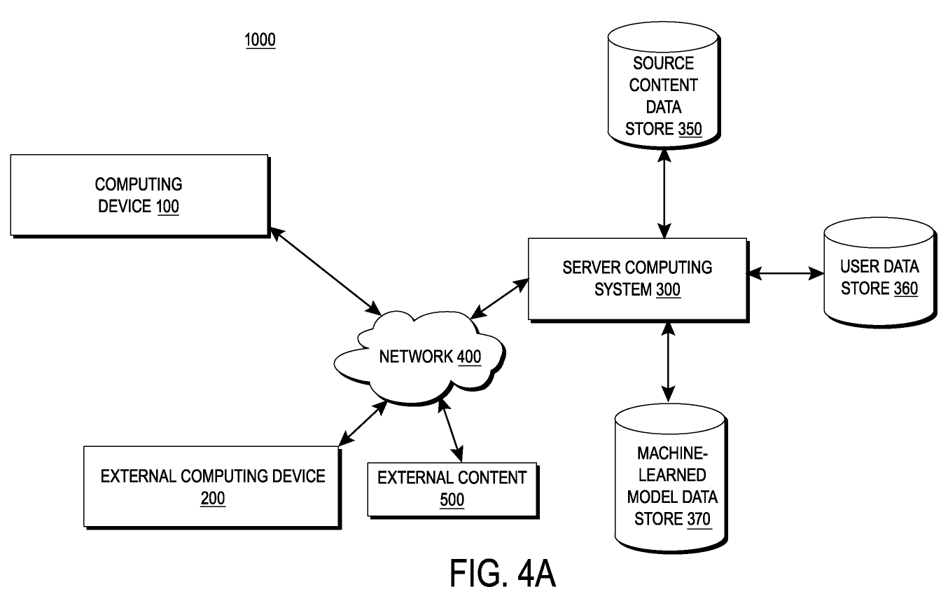

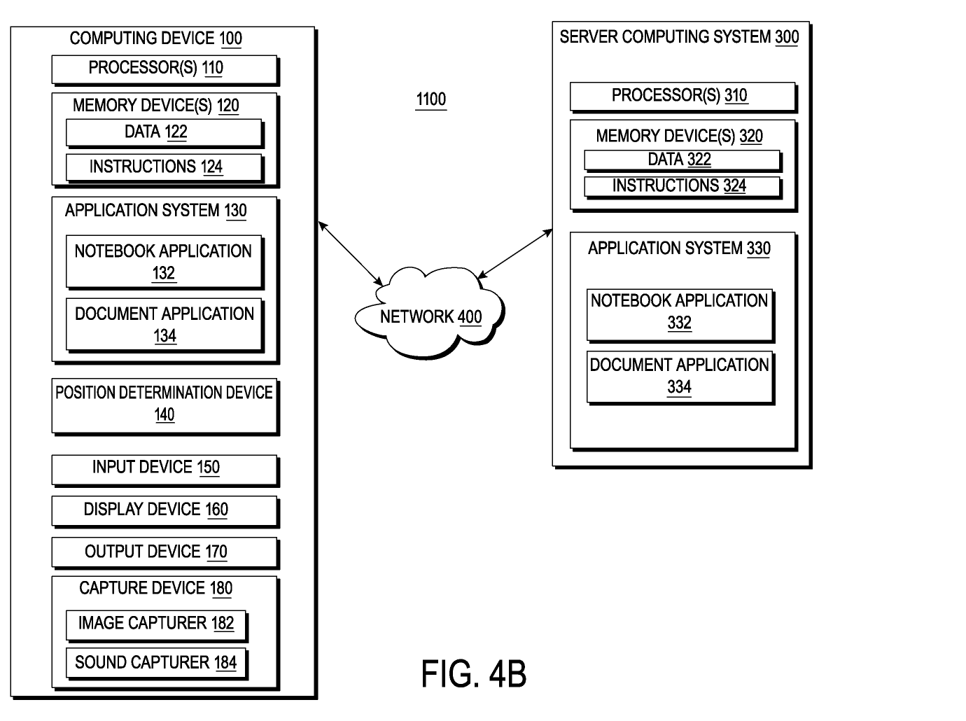

FIG. 4A is an example system according to one or more example embodiments of the disclosure. FIG. 4A illustrates an example of a system 1000 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of an application system which can provide a tool for users to manage or organize information (e.g., documents, imagery, etc.), for example, via one or more machine-learned models.

In some example embodiments, the server computing system 300 may obtain data from one or more of a source content data store 350, a user data store 360, and a machine-learned model data store 370, to implement various operations and aspects of the application system as disclosed herein. The source content data store 350, user data store 360, and machine-learned model data store 370 may be integrally provided with the server computing system 300 (e.g., as part of the one or more memory devices 320 of the server computing system 300) or may be separately (e.g., remotely) provided. Further, source content data store 350, user data store 360, and machine-learned model data store 370 can be combined as a single data store (database), or may include a plurality of respective data stores. Data stored in one data store (e.g., the source content data store 350) may overlap with some data stored in another data store (e.g., the user data store 360). In some implementations, one data store (e.g., the machine-learned model data store 370) may reference data that is stored in another data store (e.g., the user data store 360).

In some examples, the source content data store 350 can store any kind of information or content. For example, the source content data store 350 can include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, information may be stored in the source content data store 350 by the user selecting certain documents, images, or other content to store in the source content data store 350.

In some examples, the user data store 360 can include information regarding one or more user profiles, including a variety of user data such as user preference data, user demographic data, user calendar data, user social network data, user historical travel data, and the like. For example, the user data store 360 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, the data can be analyzed to determine preferences of the user with respect to generating, managing, and/or organizing content, for example, to automatically generate a summary of a document in a particular manner or style, automatically provide customized features with respect to content, to provide suggestions, recommendations, and/or questions relating to certain content identified by the user as source content, etc.

The user data store 360 is provided to illustrate potential data that could be analyzed, in some embodiments, by the computing device 100 and/or server computing system 300 to identify user preferences, to make recommendations, to generate, manage, and/or organize content, etc.. However, such user data may not be collected, used, or analyzed unless the user has consented after being informed of what data is collected and how such data is used. Further, in some embodiments, the user can be provided with a tool (e.g., in a notebook application or via a user account) to revoke or modify the scope of permissions. In addition, certain information or data can be treated in one or more ways before it is stored or used, so that personally identifiable information is removed or stored in an encrypted fashion. Thus, particular user information stored in the user data store 360 may or may not be accessible to the computing device 100 and/or server computing system 300 based on permissions given by the user, or such data may not be stored in the user data store 360 at all.

Machine-learned model data store 370 can store machine-learned models which can be retrieved and implemented by the server computing system 300 for generating distilled or fine-tuned machine-learned models (e.g., distilled or fine-tuned generative machine-learned models) that, in some implementations, can also be provided to the computing device 100. Machine-learned model data store 370 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 370 can include generative machine-learned models respectively associated with different types of content (e.g., different genres or subjects, different kinds of content including imagery, videos, and text, different styles of content including outlines, reports, spreadsheets, etc.). The machine-learned models may include large language models (LLMs) (e.g., the Bidirectional Encoder Representations from Transformers (BERT) LLM) and/or general, multimodal models (e.g., Gemini). The machine-learned models may include generative AI models (e.g., Bard) which may implement generative adversarial networks (GANs), transformers, variational autoencoders (VAEs), neural radiance fields (NeRFs), and the like.

External content 500 can be any form of external content including news articles, webpages, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

Referring now to FIG. 4B, example block diagrams of a computing device and server computing system according to one or more example embodiments of the disclosure will now be described. Although computing device 100 is represented in FIG. 4B, features of the computing device 100 described herein are also applicable to the external computing device 200.

The computing device 100 may include one or more processors 110, one or more memory devices 120, an application system 130, a position determination device 140, an input device 150, a display device 160, an output device 170, and a capture device 180. The server computing system 300 may include one or more processors 310, one or more memory devices 320, and an application system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can also include data 122 and instructions 124 that can be retrieved, manipulated, created, or stored by the one or more processors 110. In some example embodiments, such data can be accessed and used as input to implement notebook application 132, and to execute the instructions to perform operations including: providing a user interface including a first portion and a second portion, wherein the first portion includes a textual summary generated via one or more machine-learned models based on a plurality of documents selected by a user and the second portion includes a plurality of user interface elements to perform an operation with respect to the textual summary, as described according to examples of the disclosure.

For example, the one or more memory devices 320 can also include data 322 and instructions 324 that can be retrieved, manipulated, created, or stored by the one or more processors 310. In some example embodiments, such data can be accessed and used as input to implement notebook application 332, and to execute the instructions to perform operations including: providing a user interface including a first portion and a second portion, wherein the first portion includes a textual summary generated via one or more machine-learned models based on a plurality of documents selected by a user and the second portion includes a plurality of user interface elements to perform an operation with respect to the textual summary, as described according to examples of the disclosure.

In some example embodiments, the computing device 100 includes an application system 130. For example, the application system 130 may include the notebook application 132 and a document application 134 (e.g., a word processing application, a spreadsheet application, a presentation application, an imagery application, etc.). The application system 130 can include various other applications including text messaging applications, email applications, dictation applications, virtual keyboard applications, browser applications, map applications, social media applications, navigation applications, etc.

According to examples of the disclosure, the notebook application 132 may be executed by the computing device 100 to provide a user of the computing device 100 a way to organize, manage, create, and interact with content, particularly with content that is curated or selected by the user. In some implementations, the notebook application 132 may be part of document application 134, or may be a standalone application. The notebook application 132 may be configured to be dynamically interactive according to various user inputs. Example implementations of the notebook application 132 are described herein, however the disclosure is not limited to these examples as various modifications may be made to the embodiments described herein.

In some examples, one or more aspects of the notebook application 132 may be implemented by the notebook application 332 of the server computing system 300 which may be remotely located, to organize, manage, create, and interact with content, in response to receiving an input from a user. In some examples, one or more aspects of the notebook application 332 may be implemented by the notebook application 132 of the computing device 100, to organize, manage, create, and interact with content, in response to receiving an input from a user.

According to examples of the disclosure, the document application 134 may be executed by the computing device 100 to provide a user of the computing device 100 a way to organize, manage, create, and interact with content, particularly with content that is curated or selected by the user. The document application 134 can be any kind of application that pertains to documents (e.g., in a textual or visual format), and can include word processing applications, spreadsheet applications, presentation applications, visual applications, portable document format file applications, etc. In some implementations, the notebook application 132 and document application 134 may interact with each other. For example, content from a document that is created via document application 134 may be uploaded or stored for use with notebook application 132. In some implementations, notebook application 132 may be configured to generate a document (e.g., a report, an outline, a presentation, a spreadsheet) which can be compatible with (opened by or exported to) the document application 134.

In some examples, the document application 134 can be a dedicated application specifically designed to provide a particular service. In other examples, the document application 134 can be a general application (e.g., a web browser) and can provide access to a variety of different services via the network 400.

In some example embodiments, the computing device 100 includes a position determination device 140. Position determination device 140 can determine a current geographic location of the computing device 100 and communicate such geographic location to server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the computing device 100.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for selecting content that is to be organized or managed, for selecting queries or actions with respect to content that is curated or selected by the user, etc.

The computing device 100 may include a display device 160 which displays information viewable by the user (e.g., a user interface screen). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the computing device 100 to display information to a user relating to an input (e.g., information relating to a document, to a note, to a project, etc., a user interface screen having user interface elements which are selectable by the user, etc.).

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like). For example, the capture device 180 can include a sound capturer 184 (e.g., a microphone) which is configured to capture sound or audio (e.g., an audio recording) of a location. The media content captured by the capture device 180 may be transmitted to one or more of the server computing system 300, source content data store 350, user data store 360, and machine-learned model data store 370, for example, via network 400. For example, in some implementations, media content which is captured by the capture device 180 may be selected as source content by a user for use in creating a note with respect to a project. The media content can be provided as an input to one or more machine-learned models to generate a note, for example.

In accordance with example embodiments of the disclosure, the server computing system 300 can include one or more processors 310 and one or more memory devices 320 as described herein. The server computing system 300 may also include an application system 330 which is similar to the application system 130 described herein.

For example, the application system 330 may include a notebook application 332 which performs functions similar to those discussed above with respect to notebook application 132. In some implementations, one or more machine-learned models (e.g., generative machine-learned models, large language models, etc.) associated with the application system 330 may be configured to organize, manage, create, and interact with content based on source content that is curated or selected by a user. For example, one or more machine-learned models (e.g., generative machine-learned models, large language models, etc.) associated with the application system 330 may be configured to perform a first action (e.g., generate a summary or document guide with respect to source content selected by a user), while the computing device 100 may be configured to perform a second action (e.g., generate suggested actions, generate an outline or study guide based on a plurality of notes saved to a scratchpad). For example, a particular action to be performed by the application system 330 may vary according to a network status (e.g., an available bandwidth, a channel utilization status, a latency status, a throughput rate, etc.). In some implementations, one or more machine-learned models associated with the application system 330 may be configured to process a user input to generate information (e.g., semantic information) which can then be provided as an input to one or more other machine-learned models (e.g., generative machine-learned models, large language models, etc.) associated with the application system 330, to generate the content to be utilized with respect to a project for the notebook application 132 and/or notebook application 332.

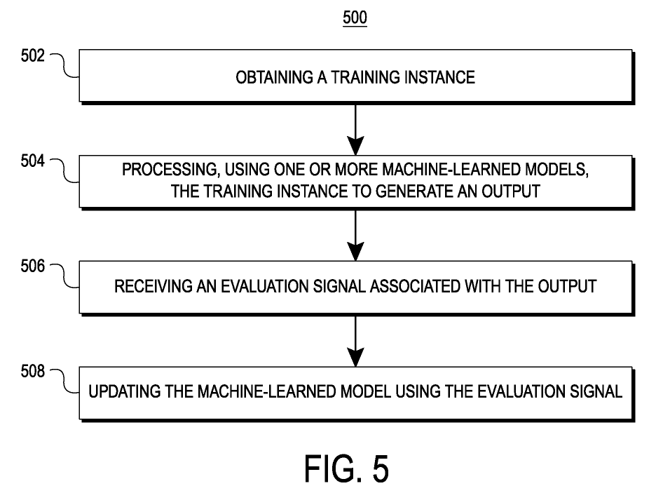

FIG. 5 depicts a flowchart of a method 500 for training one or more machine-learned models according to aspects of the present disclosure. For instance, an example machine-learned model can include a sequence processing model.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

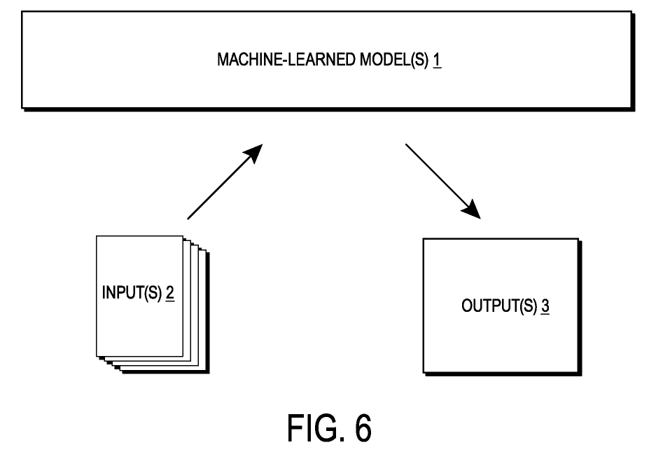

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of any other machine-learned component described herein, etc. Although various features, variations, and implementations described below are described with respect to machine-learned model(s) 1, it is to be understood that such features, variations, and implementations are to be understood as described with respect to each of any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer’s central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

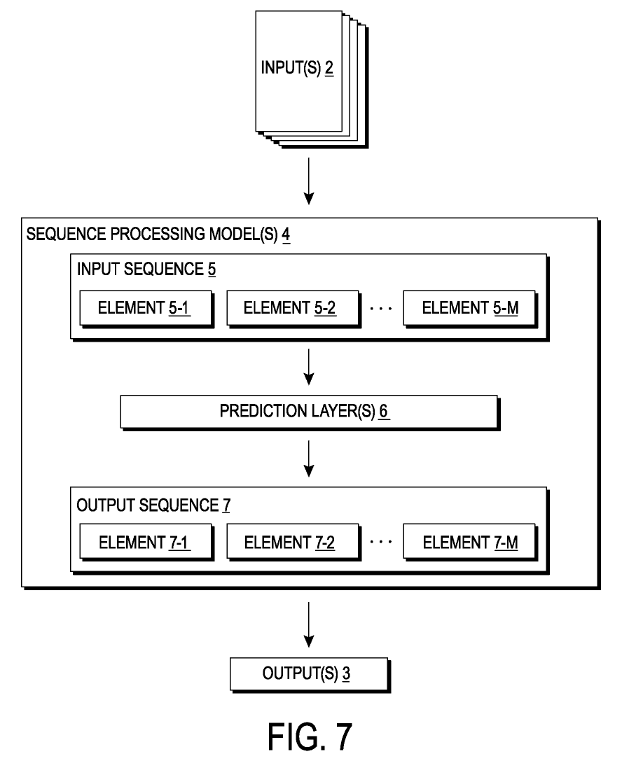

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-M, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google, https://arxiv.org/abs/2403.08295; Gemma 2: Improving Open Language Models at a Practical Size, Google, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google, https://arxiv.org/abs/2407.07726; PaliGemma 2: A Family of Versatile VLMs for Transfer, Google, https://arxiv.org/abs/2412.03555; Flamingo: a Visual Language Model for Few-Shot Learning, Google, https://arxiv.org/abs/2204.14198; PaLI: A Jointly-Scaled Multilingual Language-Image Model, Google, https://arxiv.org/abs/2209.06794.

Sequence processing model(s) 4 can be multimodal. Example multimodal sequence processing models include, for instance, models described in Gemini: A Family of Highly Capable Multimodal Models, Google, https://arxiv.org/abs/2312.11805; Gemini 1.5: Unlocking multimodal understanding across millions of tokens of context, Google , https://arxiv.org/abs/2403.05530.

Other example sequence processing models can operate to generate outputs or receive inputs in specific domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing

(System Demonstrations), pages 66–71 (Oct. 31–Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

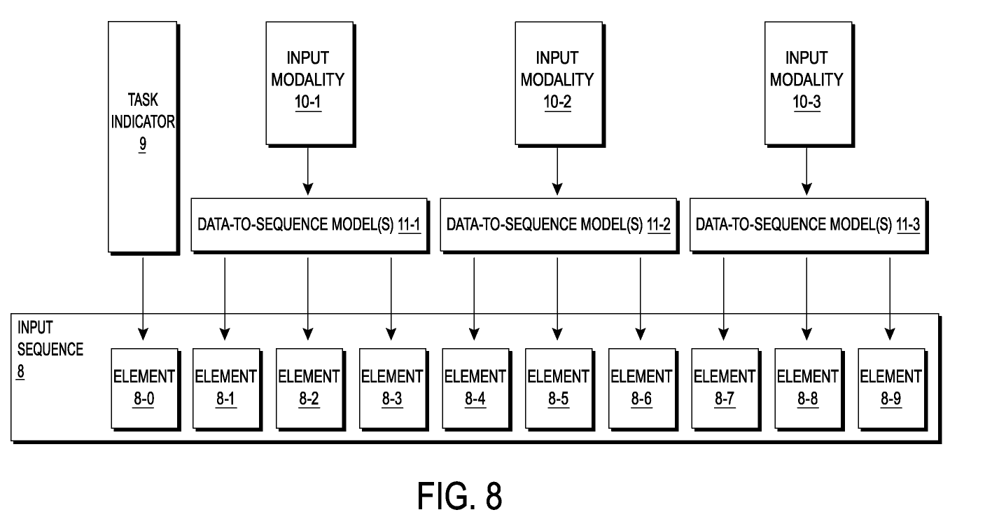

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

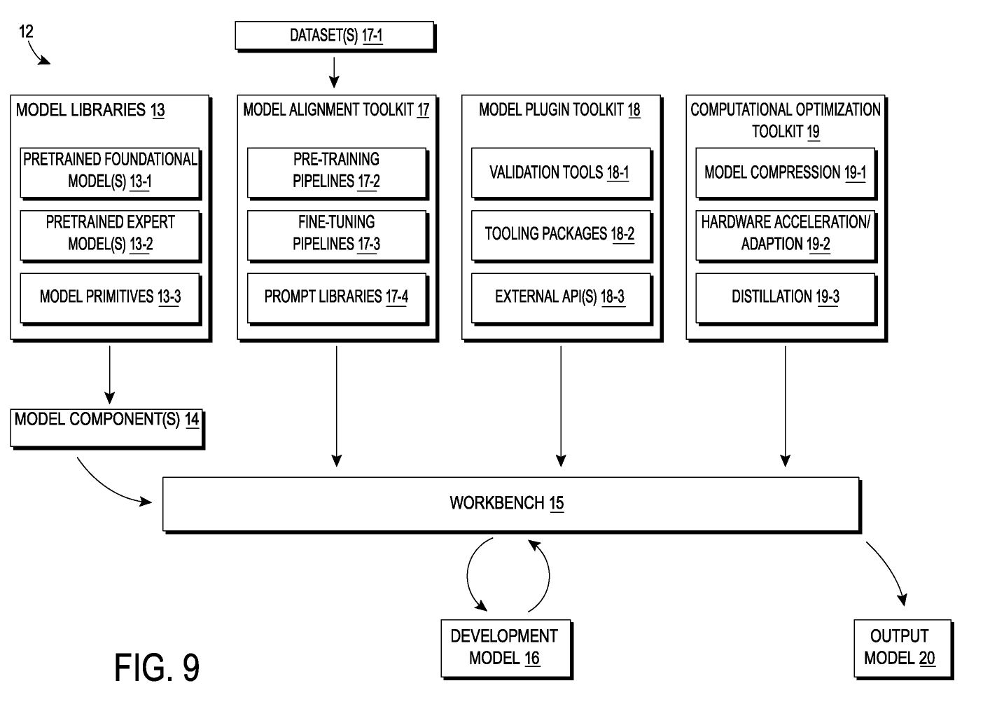

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

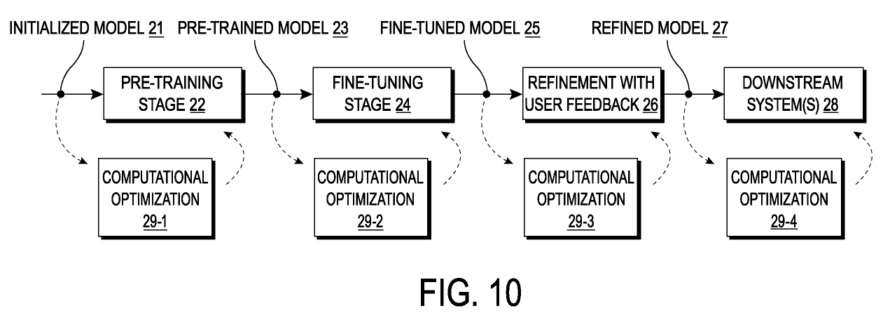

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

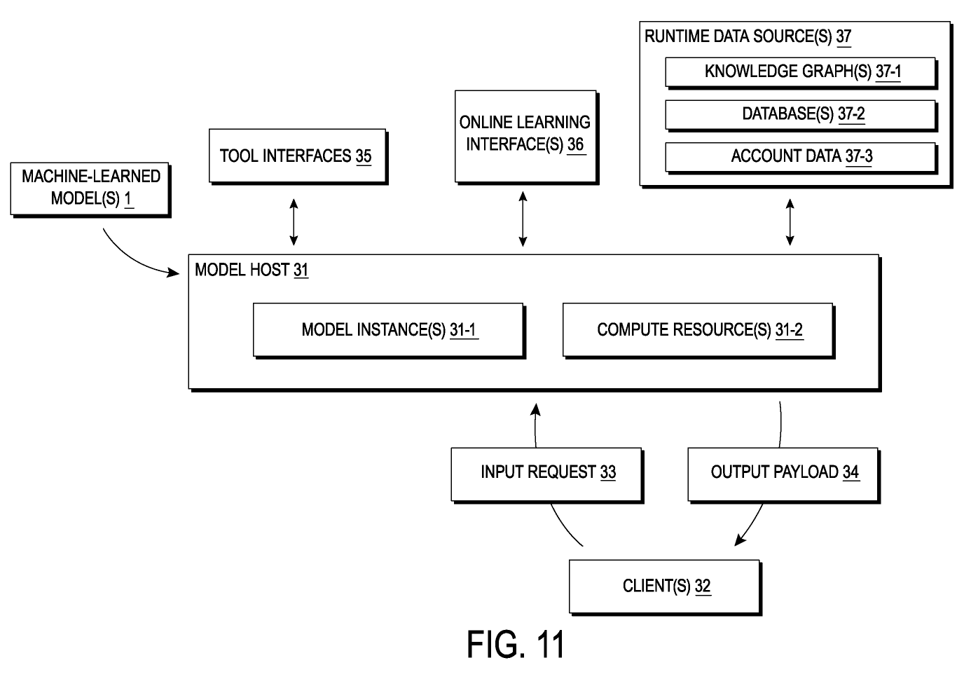

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 32 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

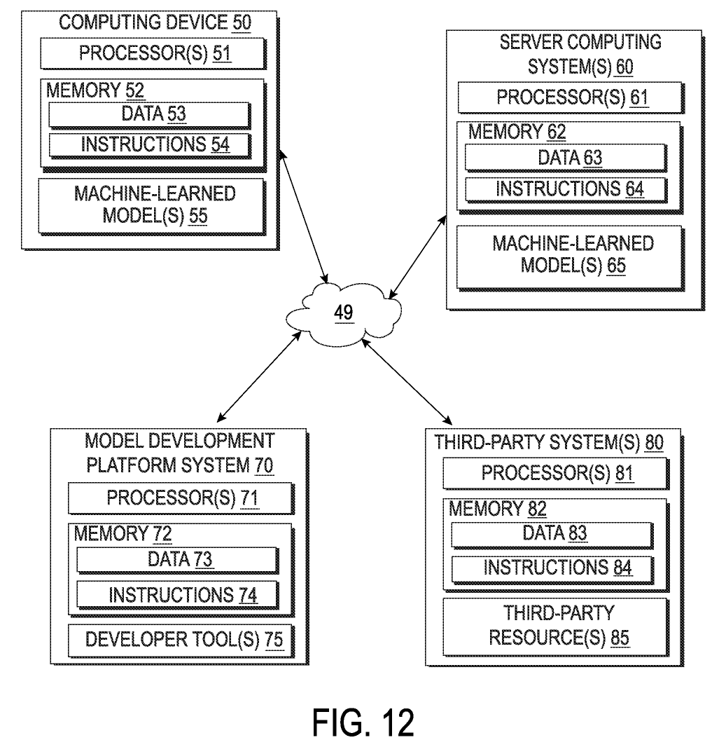

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provider that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

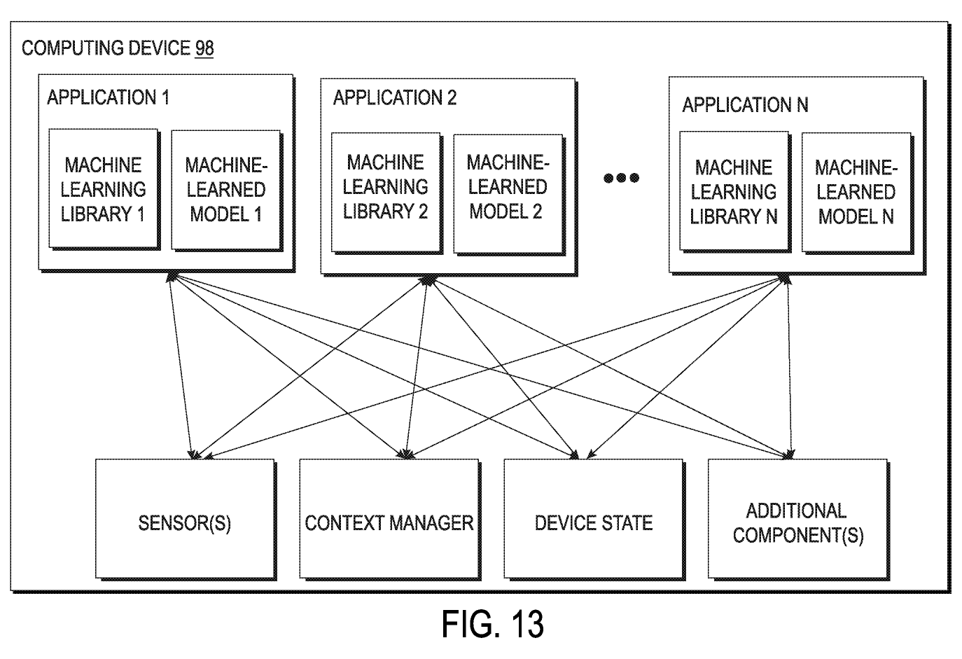

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

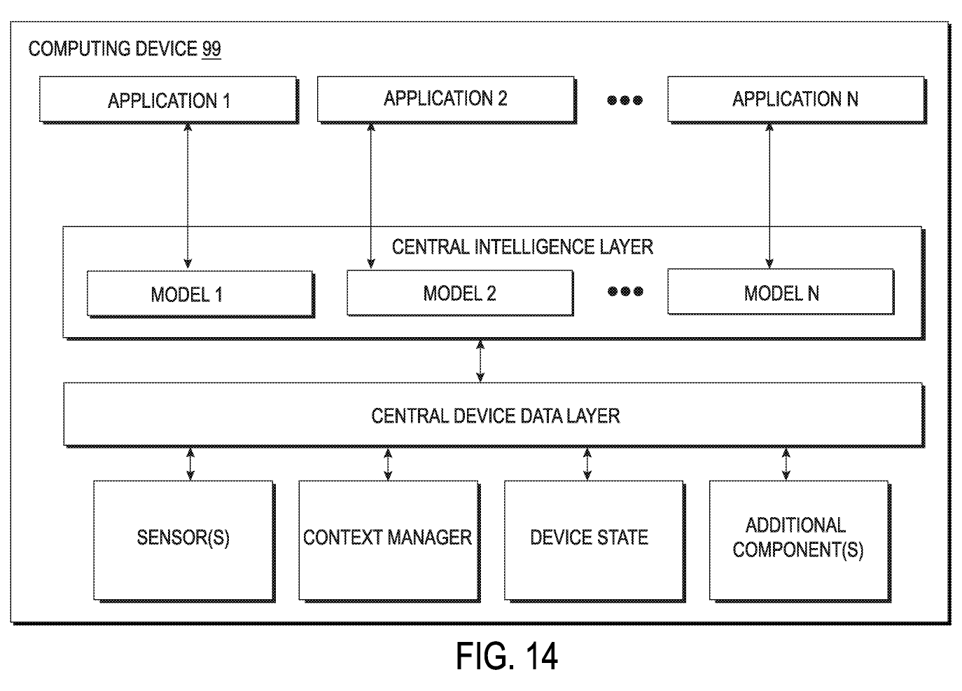

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method to perform automated topic exploration, the method comprising:
receiving, by a computing system comprising one or more computing devices, a request to initiate an automated topic exploration;
in response to the request, processing, by the computing system, a model input with a machine-learned topic generation model to generate a topic statement as an output of the machine-learned topic generation model;
generating, by the computing system, a plurality of information retrieval queries that query for source documents related to the topic statement;
causing, by the computing system, the plurality of information retrieval queries to be executed on one or more information retrieval systems to return a plurality of candidate source documents that are responsive to the plurality of information retrieval queries; and
collecting, by the computing system at least a subset of the plurality of candidate source documents into a proposed set of source documents.

2. The computer-implemented method of claim 1, wherein the request to initiate the automated topic exploration is responsive to a user input that selects a user interface element that initiates the automated topic exploration.

3. The computer-implemented method of claim 1, wherein processing, by the computing system, the model input with the machine-learned topic generation model to generate the topic statement as the output of the machine-learned topic generation model comprises:
randomly selecting, by the computing system, two or more seed data elements from a corpus of data elements, each data element in the corpus of data elements comprising textual content, image content, or audio content; and
processing, by the computing system, the two or more seed data elements with the machine-learned topic generation model to generate the topic statement as the output of the machine-learned topic generation model.

4. The computer-implemented method of claim 3, wherein the two or more seed data elements comprise two or more words.

5. The computer-implemented method of claim 4, wherein the two or more words comprise two or more nouns.

6. The computer-implemented method of claim 3, wherein the corpus of data elements is dynamically modified based on user information associated with a user.

7. The computer-implemented method of claim 3, wherein the corpus of data elements is dynamically modified based on current news events.

8. The computer-implemented method of claim 3, wherein processing, by the computing system, the two or more seed data elements with the machine-learned topic generation model comprises processing, by the computing system, the two or more seed data elements with the machine-learned topic generation model along with a topic generation prompt that instructs the machine-learned topic generation model regarding generation of the topic statement based on the two or more seed data elements.

9. The computer-implemented method of claim 1, wherein generating, by the computing system, the plurality of information retrieval queries that query for source documents related to the topic statement comprises:
processing, by the computing system, the topic statement with one or more machine-learned query generation models to generate one or more of the plurality of information retrieval queries as outputs of the one or more machine-learned query generation models.

10. The computer-implemented method of claim 9, wherein processing, by the computing system, the topic statement with one or more machine-learned query generation models comprises processing, by the computing system, the topic statement along with a query generation prompt with one or more machine-learned query generation models to generate one or more of the plurality of information retrieval queries as outputs of the one or more machine-learned query generation models, wherein the query generation prompt instructs the one or more machine-learned query generation models regarding generation of the one or more of the plurality of information retrieval queries based on the topic statement.

11. The computer-implemented method of claim 1, wherein generating, by the computing system, the plurality of information retrieval queries that query for source documents related to the topic statement comprises:
heuristically generating, by the computing system, one or more of the plurality of information retrieval queries from the topic statement.

12. The computer-implemented method of claim 1, wherein the one or more information retrieval systems comprise a web search engine.

13. The computer-implemented method of claim 1, wherein the plurality of candidate source documents comprise web documents.

14. The computer-implemented method of claim 1, wherein the one or more information retrieval systems comprise an enterprise document storage system.

15. The computer-implemented method of claim 1, wherein collecting, by the computing system at least the subset of the plurality of candidate source documents into the proposed set of source documents comprises:
filtering, by the computing system, the plurality of candidate source documents based on one or more source document selection criteria to generate the proposed set of source documents.

16. The computer-implemented method of claim 1, wherein collecting, by the computing system at least the subset of the plurality of candidate source documents into the proposed set of source documents comprises:
processing, by the computing system, the plurality of candidate source documents with one or more machine-learned result selection models to generate, as an output of the one or more machine-learned result selection models, a selection or ranking of the plurality of candidate source documents into the proposed set of source documents.

17. The computer-implemented method of claim 16, wherein processing, by the computing system, the plurality of candidate source documents with one or more machine-learned result selection models comprises:
processing, by the computing system, the plurality of candidate source documents and a source document selection prompt with one or more machine-learned result selection models, wherein the source document selection prompt instructs the one or more machine-learned result selection models regarding one or more source document selection criteria.

18. The computer-implemented method of claim 17, wherein the one or more source document selection criteria comprise a cohesion criteria and a progressive complexity criteria.

19. The computer-implemented method of claim 1, further comprising:
providing for display, by the computing system, a graphical user interface that identifies the proposed set of source documents;
receiving, by the computing system, a user input that selects one or more of the source documents from the proposed set of source documents; and
in response to the user input, creating, by the computing system, within an interactive notebook application, a new notebook that contains the one or more source documents selected by the user input.

20. A computing system comprising:
one or more processors; and
one or more non-transitory computer-readable media that collectively store instructions that, when executed by the one or more processors, cause the computing system to perform operations, the operations comprising:
receiving, by the computing system, a request to initiate an automated topic exploration;
in response to the request, processing, by the computing system, a model input with a machine-learned topic generation model to generate a topic statement as an output of the machine-learned topic generation model;
generating, by the computing system, a plurality of information retrieval queries that query for source documents related to the topic statement;
causing, by the computing system, the plurality of information retrieval queries to be executed on one or more information retrieval systems to return a plurality of candidate source documents that are responsive to the plurality of information retrieval queries; and
collecting, by the computing system at least a subset of the plurality of candidate source documents into a proposed set of source documents.
